(19) United States
(12) Patent Application Publication
(10) Pub. No.: US 2018/0290155 A1
(43) Pub. Date: Oct. 11, 2018

(54) Showerhead Structure

(71) Applicant: Shih-Yu Chung, Lukang Township (TW)

(72) Inventor: Shih-Yu Chung, Lukang Township (TW)

(21) Appl. No.: 16/003,200

(22) Filed: Jun. 8, 2018

Related U.S. Application Data
(63) Continuation-in-part of application No. 15/060,867, filed on Mar. 4, 2016.

(30) Foreign Application Priority Data
Apr. 29, 2015 (TW) 104206572

(51) Int. Cl. B05B 1/18

(52) U.S. Cl. CPC B05B 1/185; B05B 1/048

(57) ABSTRACT

A showerhead structure contains: a water supply disc, a water guiding disc, a covering casing, and a decoration cover. The water supply disc includes multiple through orifices. The water guiding disc contacts with a second face of the water supply disc and includes multiple spray protrusion inserted into the multiple through orifices respectively, each spray protrusion has a peripheral trench extending out of a first face of the water supply disc, and a retaining space is defined outside the water supply disc. The covering casing is covered on the second face so as to clamp the water guiding disc between the covering casing and the water supply disc and includes a body and multiple locking holes. Each locking hole retains in the retaining space of the peripheral trench of each spray protrusion of the water guiding disc extending out of the first face of the water supply disc.

This application is a Continuation-in-Part of application Ser. No. 15/060,867, filed Mar. 4, 2016.

### BACKGROUND OF THE INVENTION

### Field of the Invention

The present invention relates to a showerhead structure which has aesthetics appearance and is machined easily.

### Description of the Prior Art

Shower equipment contains a fixed showerhead and a manual showerhead, wherein the fixed showerhead is mounted on a wall and is in connection with a water pipe so that water flows into the fixed showerhead and then sprays out of spray nozzles of the fixed showerhead downwardly, thus taking a shower. This fixed showerhead is assembled easily and securely, but its size and aesthetics appearance cannot be improved greatly.

With reference to FIGS. 12-14, a fixed showerhead structure contains a case 10, a water supply cover 20, a water disc 30, a locking disc 40, and an outflow disc 50.

The case 10 includes a fitting orifice 101 defined on a top thereof, the water supply cover 20 is in a circular disk shape and includes a peripheral rib 201 arranged around a rim of the water supply cover 20, and the peripheral rib 201 has multiple fixing orifices 2011 equidistantly defined thereon so as to accommodate multiple screws 2012 respectively. The water disc 30 includes a stop rib 301 arranged around a rim thereof, includes multiple outlets 302 formed on the water disc 30, and multiple hollow columns 3021 extending downward from bottoms of the multiple outlets 302 individually. The locking disc 40 includes a protruded rib 401 arranged around a rim of a top thereof, multiple notches 402 equidistantly defined around the top of the protruded rib 401 outside the rim of the top of the locking disc 40, and multiple through holes 403 formed inside the protruded rib 401 and corresponding to the multiple hollow columns 3021 of the water disc 30 individually. The outflow disc 50 includes multiple orifices 501 corresponding to the through holes 403 of the locking disc 40 respectively, and multiple hollow spray protrusions 502 extending through the multiple orifices 501 of the outflow disc 50 and the multiple through holes 403 of the locking disc 40 respectively, wherein the multiple hollow columns 3021 of the water disc 30 insert into the multiple hollow spray protrusions 502 of the outflow disc 50 respectively.

In assembly, the locking disc 40 is stacked on the outflow disc 50 so that the multiple hollow spray protrusions 502 are upward extended through the multiple orifices 501 of the outflow disc 50 and the multiple through holes 403 of the locking disc 40 respectively, and the multiple hollow spray protrusions 502 are riveted on the locking disc 40, such that the locking disc 40 is connected with the outflow disc 50. The water disc 30 is stacked on the locking disc 40 so that the multiple hollow columns 3021 of the water disc 30 are inserted into the multiple hollow spray protrusions 502 of the outflow disc 50 respectively, and the stop rib 301 of the water disc 30 is fitted with the protruded rib 401 of the locking disc 40. Then, the peripheral rib 201 of the water supply cover 20 is covered on the locking disc 40 so that the multiple screws 2012 of the multiple fixing orifices 2011 of the peripheral rib 201 are locked into the multiple notches 402 of the locking disc 40 individually, such that the water supply cover 20 is connected with the locking disc 40, and the case 10 is covered on the water supply cover 20, the water disc 30, the locking disc 40, and the outflow disc 50.

However, the locking disc 40 is stacked on the outflow disc 50 so that the multiple hollow spray protrusions 502 are upward extended through the multiple orifices 501 of the outflow disc 50 and the multiple through holes 403 of the locking disc 40 respectively, and the multiple hollow spray protrusions 502 are riveted on the locking disc 40. In addition, the water disc 30 is stacked on the locking disc 40 so that the multiple hollow columns 3021 of the water disc 30 are inserted into the multiple hollow spray protrusions 502 of the outflow disc 50 respectively, so the conventional fixed showerhead structure is complicated, is connected troublesomely, and is manufactured at high fabrication cost and defective rate. Due to the locking disc 40 includes the protruded rib 401 arranged around the rim of the top thereof, the multiple notches 402 equidistantly defined outside the rim of the top of the locking disc 40, and the multiple through holes 403 formed inside the protruded rib 401 and corresponding to the multiple hollow columns 3021 of the water disc 30 individually, the locking disc 40 has a specific thickness, and the conventional fixed showerhead is not slim.

To overcome above-mentioned defects, a slim fixed showerhead is disclosed in FIGS. 15-20 and contains a water supply disc 60, a water guiding disc 70, and a covering casing 80, wherein the water supply disc 60 includes a first face 601, a second face 602 opposite to the first face 601, and a plurality of orifices 603 arranged on the water supply disc 60 and communicating with the first face 601 and the second face 602. The water supply disc 60 further includes multiple locking elements 604 welded proximate to a peripheral side of the second face 602 of the water supply disc 60, and each of the multiple locking elements 604 has an inner thread.

The water guiding disc 70 is flexible and contacts with the second face 602 of the water supply disc 60, and the water guiding disc 70 includes multiple spray protrusions 701 arranged on a first surface thereof facing the water supply disc 60 and inserted into the plurality of through orifices 603 of the water supply disc 60 respectively, wherein each spray protrusion 701 has a peripheral trench 702 defined around a peripheral side thereof, and a height of the peripheral trench 702 mates with a thickness of the water supply disc 60, such that the peripheral trench 702 retains with a respective one of the plurality of through orifices 603. The covering casing 80 is covered on the second face 602 of the water supply disc 60 and includes a plurality of first fixing holes 801 corresponding to the multiple locking elements 604 of the water supply disc 60 respectively, and a plurality of screws 802 inserted through the plurality of first fixing holes 801 so as to screw with the multiple locking elements 604 of the water supply disc 60 individually, thus connecting the covering casing 80 and the water supply disc 60 together. Furthermore, an accommodation room 90 is defined between the covering casing 80 and the water guiding disc 70, and the water guiding disc 70 is clamped between the covering casing 80 and the water supply disc 60, wherein the multiple spray protrusions 701 of the water guiding disc 70 are in communication with the accommodation room 90. The covering casing 80 includes a connecting knob 803 arranged on a central position thereof and configured to connect with a water source. In operation, water flows into the accommodation room 90 between the covering casing 80 and the water guiding disc 70 from the connecting knob 803, and sprays out of the multiple spray protrusions 701 of the water guiding disc 70, hence user takes a shower.

However, the multiple locking elements 604 of the slim fixed showerhead are welded on the second face 602 of the waters supply disc 60 to cause difficult machining, poor stability, and easy removal. Moreover, a positioning error of said each locking element 604 occurs to have defective rate, and a welding defacement happens on the first face 601 of the water supply disc 60, so polishing the first face 601 of the water supply disc 60 to eliminate the welding defacement will increase machining time and high production cost. After polishing the first face 601 of the water supply disc 60, a welding trace 601A remains on a welded position so have inferior quality and appearance of the slim showerhead structure.

The present invention has arisen to mitigate and/or obviate the afore-described disadvantages.

### SUMMARY OF THE INVENTION

The primary objective of the present invention is to provide a showerhead structure which has outstanding aesthetics appearance and is machined easily in a short time.

Another objective of the present invention is to provide a showerhead structure which is manufactured at lower fabrication cost and defective rate.

To obtain above objectives, a showerhead structure provided by a preferred embodiment of the present invention contains: a water supply disc, a water guiding disc, a covering casing, and a decoration cover.

The water supply disc is made of metal material so as to withstand a water pressure, and the water supply disc includes a first face, a second face opposite to the first face, a plurality of through orifices passing through the first face and the second face, multiple fixing orifices arranged around a peripheral side of the water supply disc, and a plurality of locking elements fitted in the multiple fixing orifices respectively so as to limit rotations of the plurality of locking elements, wherein each locking element has an inner thread formed therein, and each locking element has a stop portion formed on a bottom thereof so that the stop portion of each locking element retains with the first face of the water supply disc.

The water guiding disc is flexible and contacts with the second face of the water supply disc, and the water guiding disc includes multiple spray protrusions arranged on a first surface of the water guising disc facing the water supply disc and extending out of the plurality of through orifices of the water supply disc respectively, wherein the water guiding disc includes multiple peripheral trenches defined around peripheral sides of the multiple spray protrusions respectively and extending out of the first face of the water supply disc so as to define a retaining space outside the water supply disc, and the water guiding disc also includes a plurality of apertures corresponding to the plurality of locking elements of the water supply disc.

The covering casing is covered on the second face of the water supply disc and includes multiple openings arranged adjacent to a peripheral side of the covering casing and corresponding to the plurality of locking elements of the water supply disc individually, the covering casing further includes a plurality of screws inserting through the multiple openings of the covering casing and the plurality of apertures of the water guiding disc respectively so as to screw with the plurality of locking elements of the water supply disc, such that the water guiding disc is clamped between the covering casing and the water supply disc so that an accommodation room is defined between the covering casing and the water guiding disc, and the covering casing further including a connecting knob configured to connect with a water source and to communicate with the accommodation room.

The decoration cover is made of metal material and does not withstand the water pressure, and the decoration cover includes a body corresponding to the water supply disc and contacting with the first face of the water supply disc. The decoration cover further includes a plurality of locking holes arranged on the body and corresponding to the plurality of through orifices of the water supply disc individually, wherein each locking hole retains in the retaining space of the peripheral trench of each spray protrusion of the water guiding disc extending out of the first face of the water supply disc, such that the decoration cover contacts with the first face of the water supply disc.

### BRIEF DESCRIPTION OF THE DRAWINGS

FIG. 1 is a perspective view showing the assembly of a showerhead structure in accordance with a preferred embodiment of the present invention.

FIG. 2 is a perspective view showing the exploded components of the showerhead structure in accordance with the preferred embodiment of the present invention.

FIG. 2-1 is an amplified perspective view of a circle portion of FIG. 2.

FIG. 2-2 is another perspective view showing the exploded components of the showerhead structure in accordance with the preferred embodiment of the present invention.

FIG. 3 is also another perspective view showing the assembly of the showerhead structure in accordance with the preferred embodiment of the present invention.

FIG. 4 is a cross sectional view showing the assembly of the showerhead structure in accordance with the preferred embodiment of the present invention.

FIG. 5 is an amplified cross-sectional of a portion A1 of FIG. 4.

FIG. 6 is a cross sectional view showing the assembly of a part of the showerhead structure in accordance with the preferred embodiment of the present invention.

FIG. 7 is an amplified cross-sectional view of a portion A2 of FIG. 6.

FIG. 8 is another cross sectional view showing the assembly of the showerhead structure in accordance with the preferred embodiment of the present invention.

FIG. 9 is an amplified cross-sectional view of a portion A3 of FIG. 8.

FIG. 10 is also another cross sectional view showing the assembly of the showerhead structure in accordance with the preferred embodiment of the present invention.

FIG. 11 is an amplified cross-sectional view of a portion A4 of FIG. 10.

FIG. 12 is a perspective view showing the exploded components of a conventional showerhead structure.

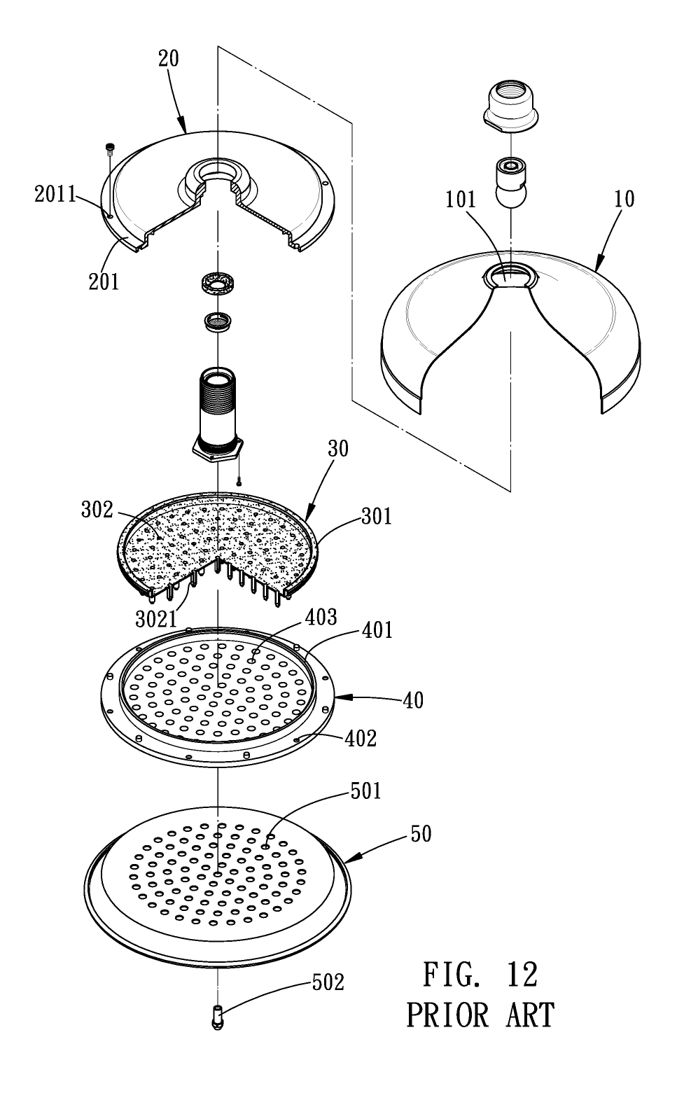

FIG. 13 is a cross sectional view showing the assembly of the conventional showerhead structure.

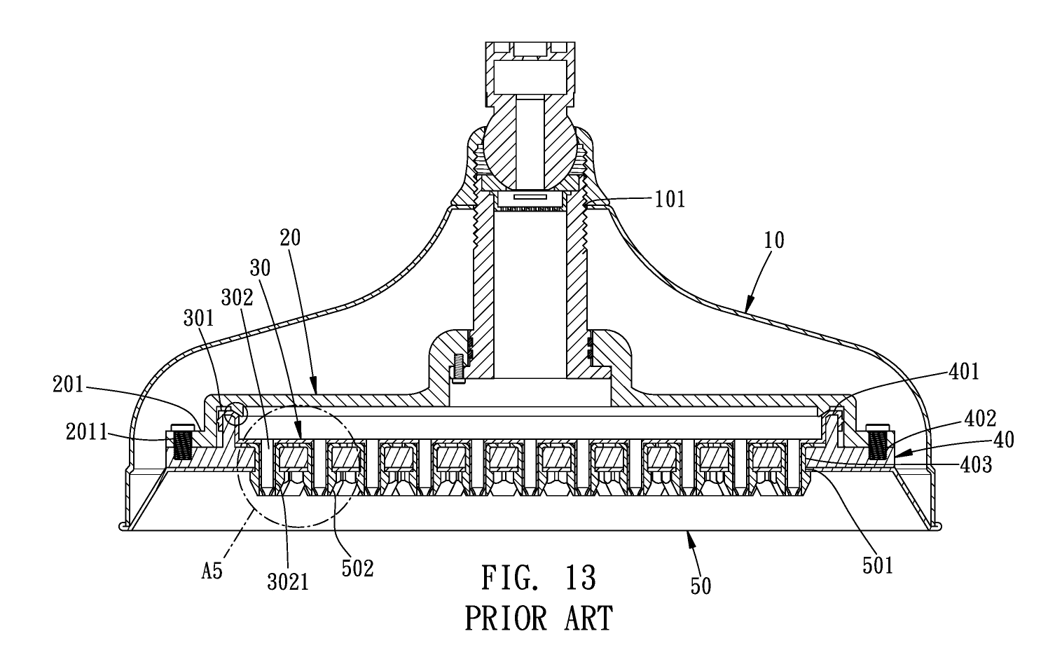

FIG. 14 is an amplified cross-sectional view of a portion A5 of FIG. 13.

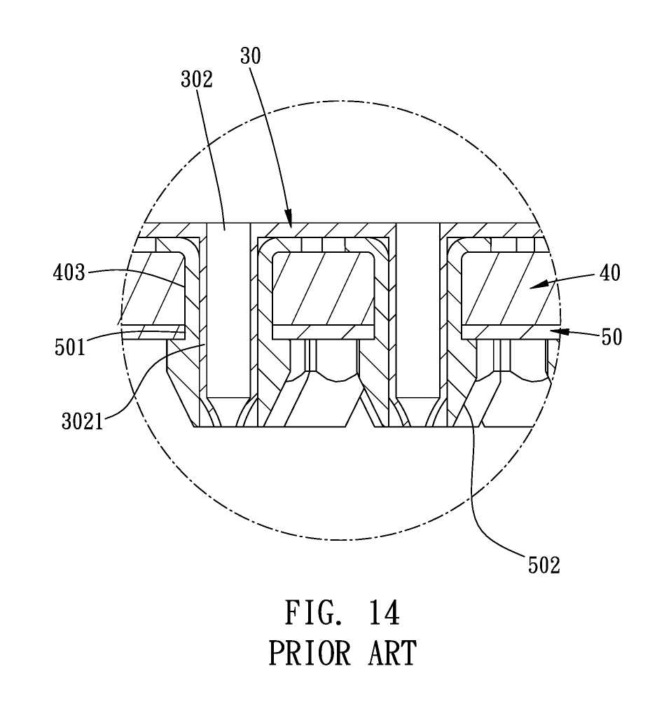

FIG. 15 is a perspective view showing the exploded components of another conventional showerhead structure.

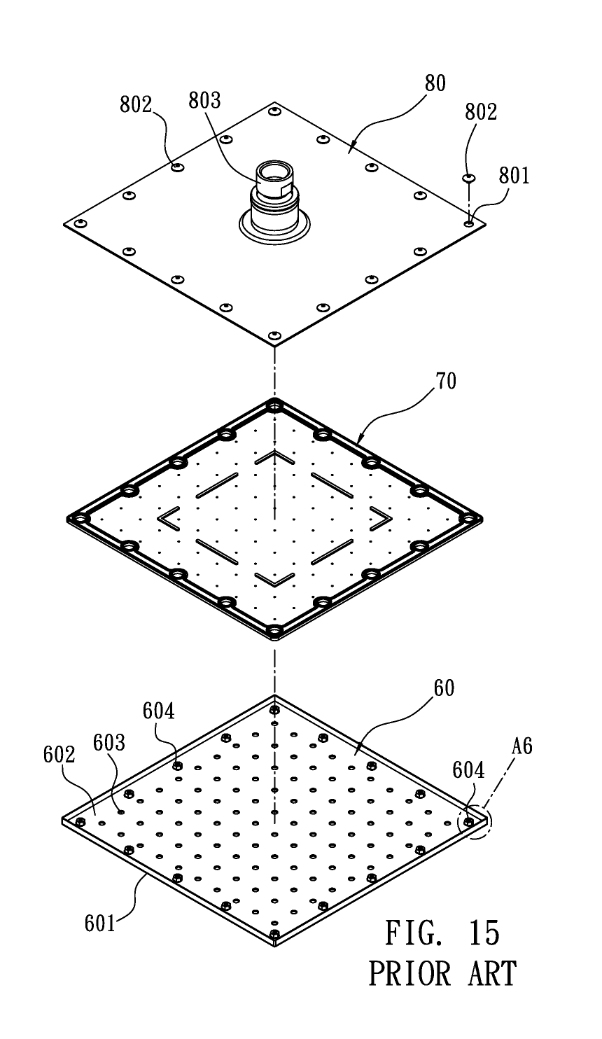

FIG. 16 is an amplified perspective view of a portion A6 of FIG. 15.

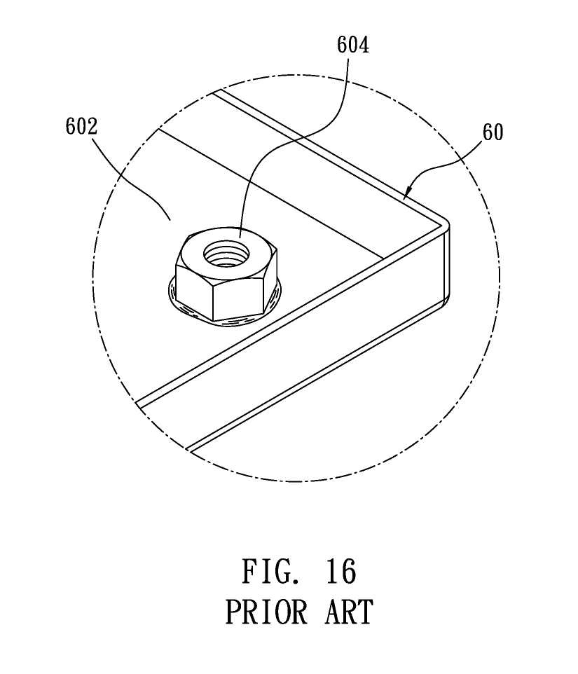

FIG. 17 is a perspective view showing the assembly of another conventional showerhead structure.

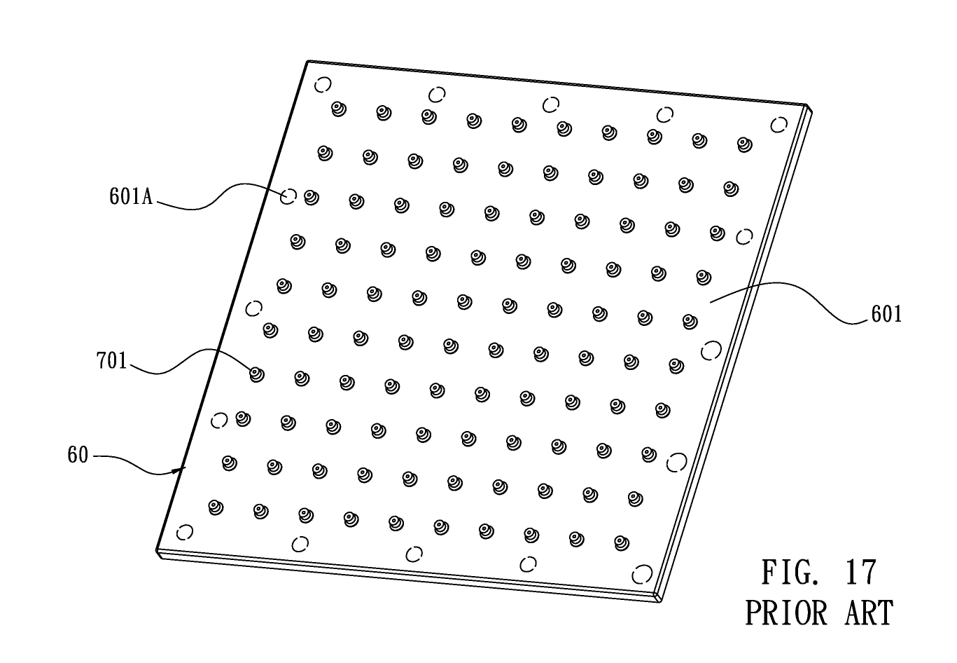

FIG. 18 is a cross sectional view showing the assembly of another conventional showerhead structure.

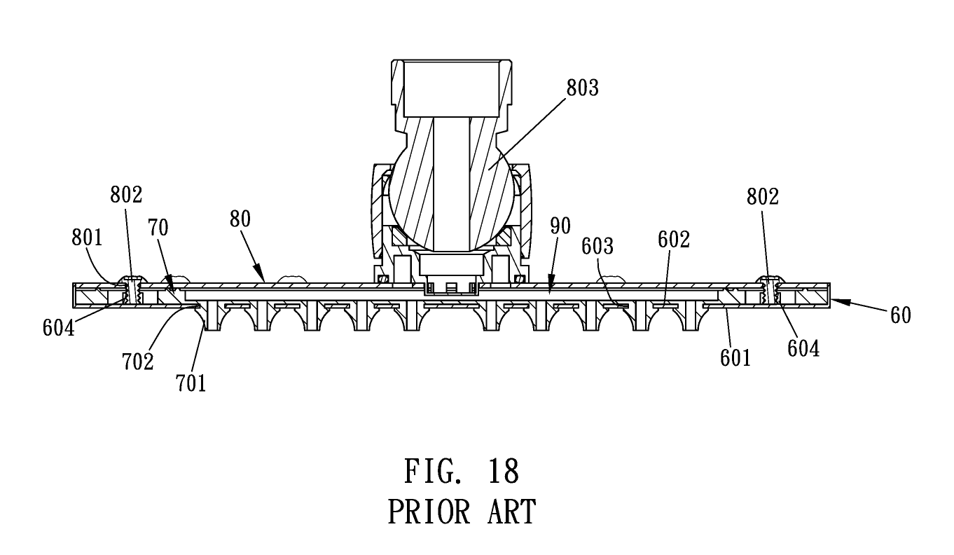

FIG. 19 is a cross sectional view showing the assembly of a part of another conventional showerhead structure.

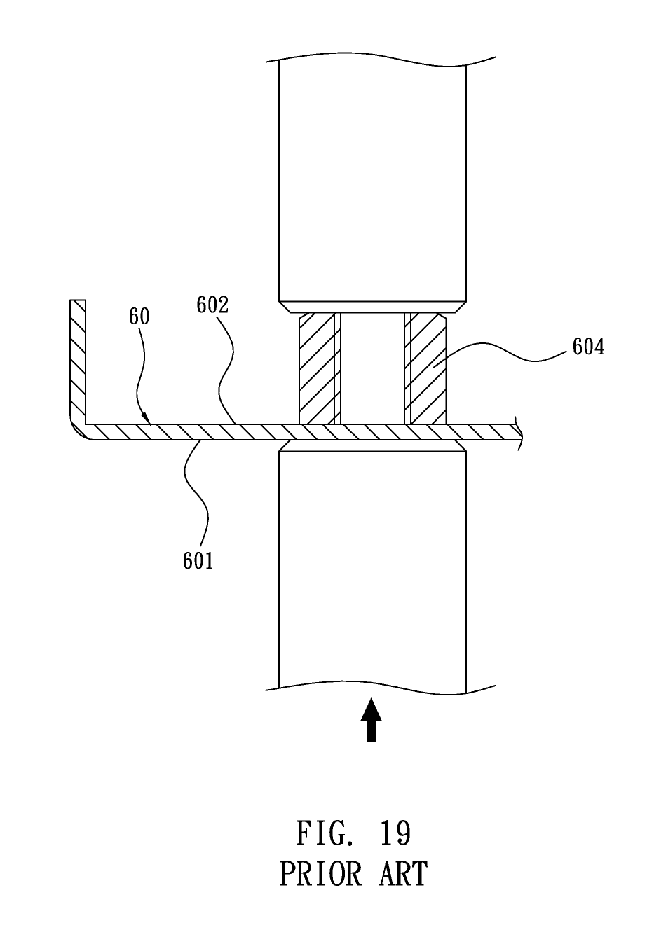

FIG. 20 is another cross sectional view showing the assembly of a part of another conventional showerhead structure.

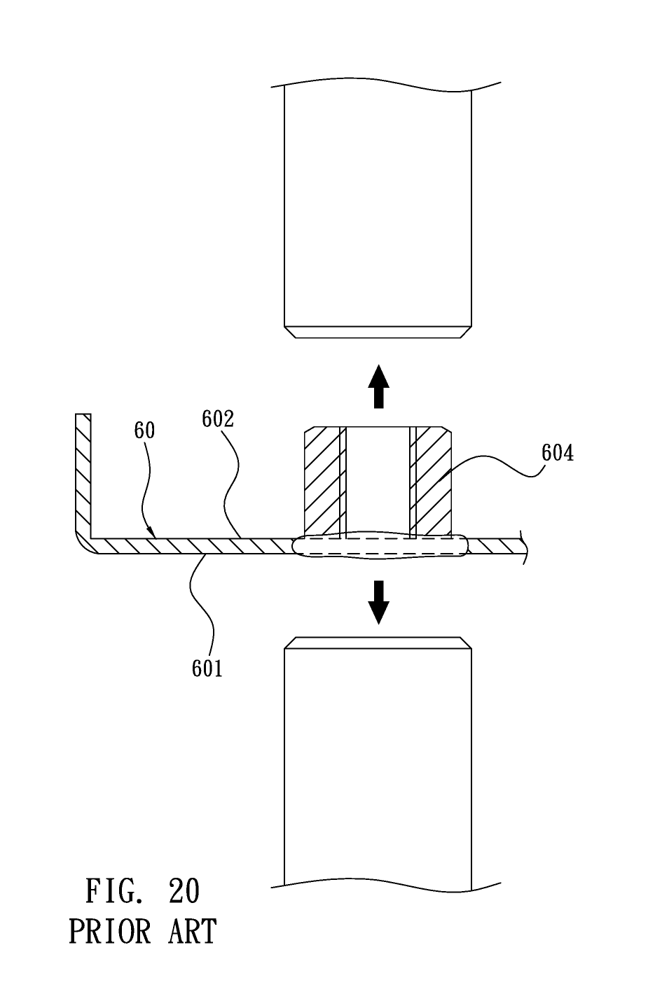

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

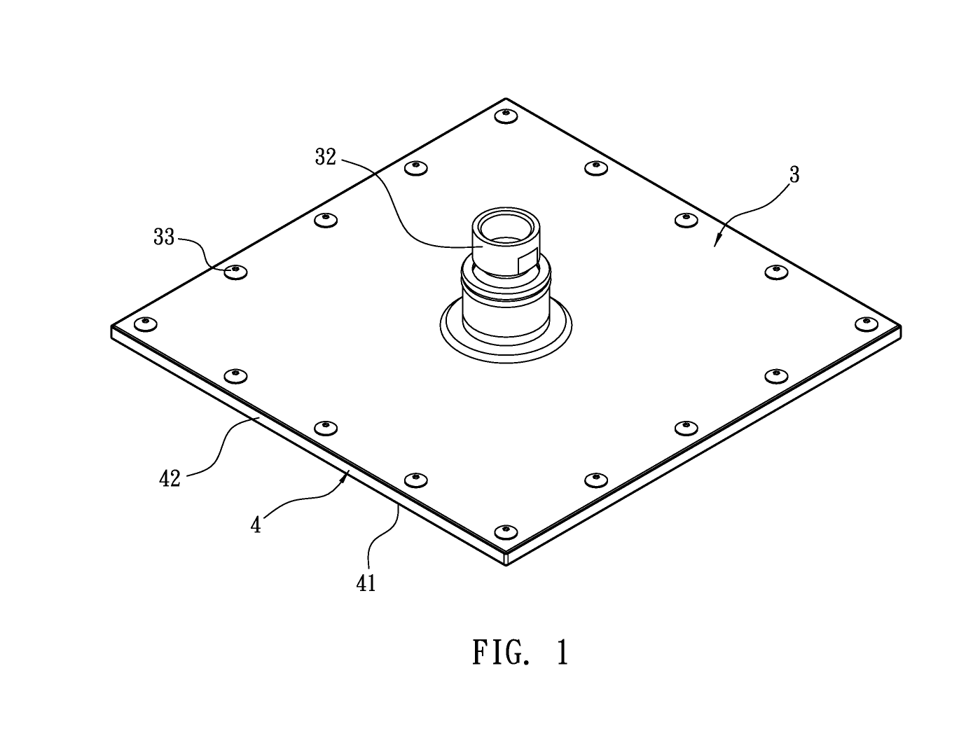

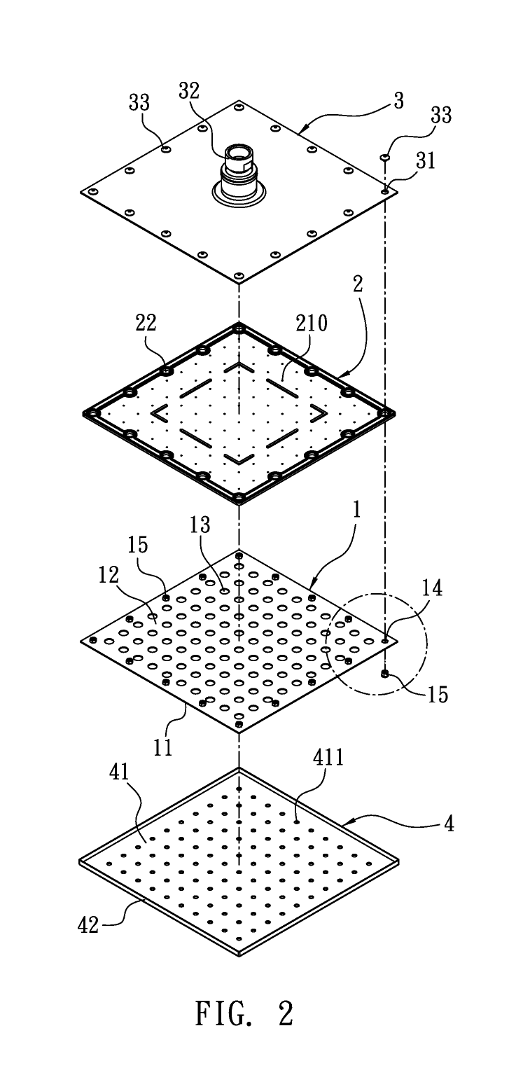

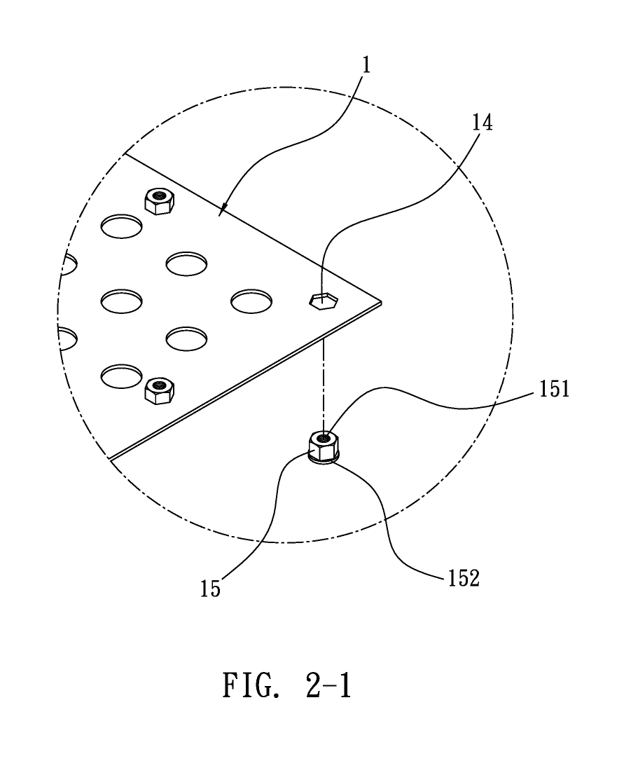

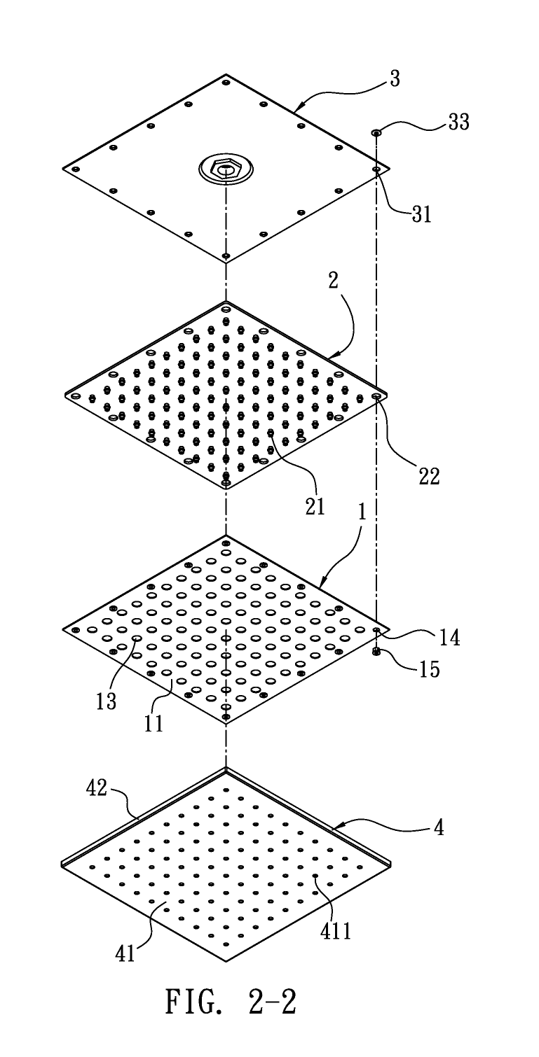

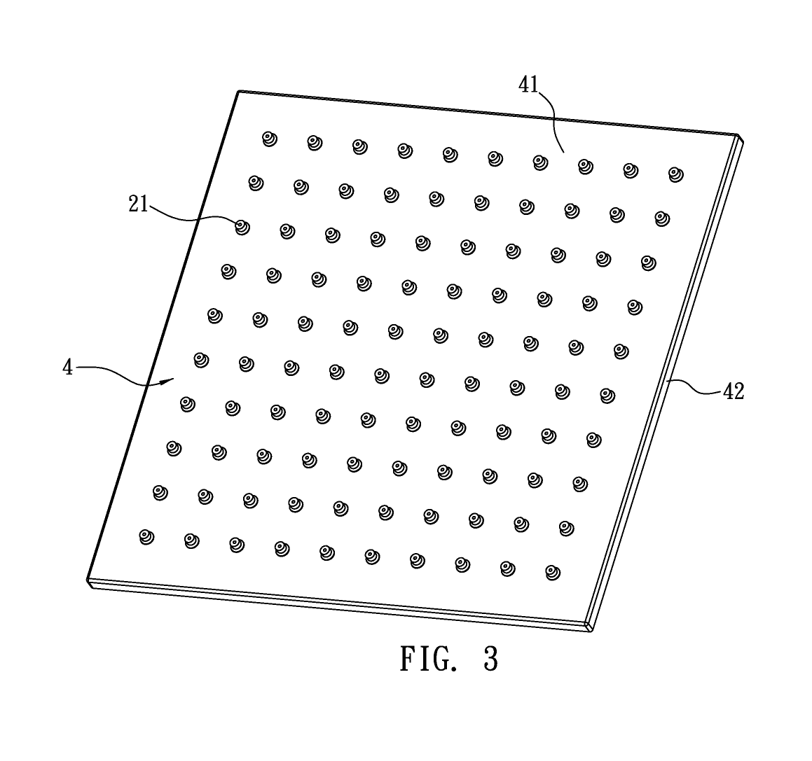

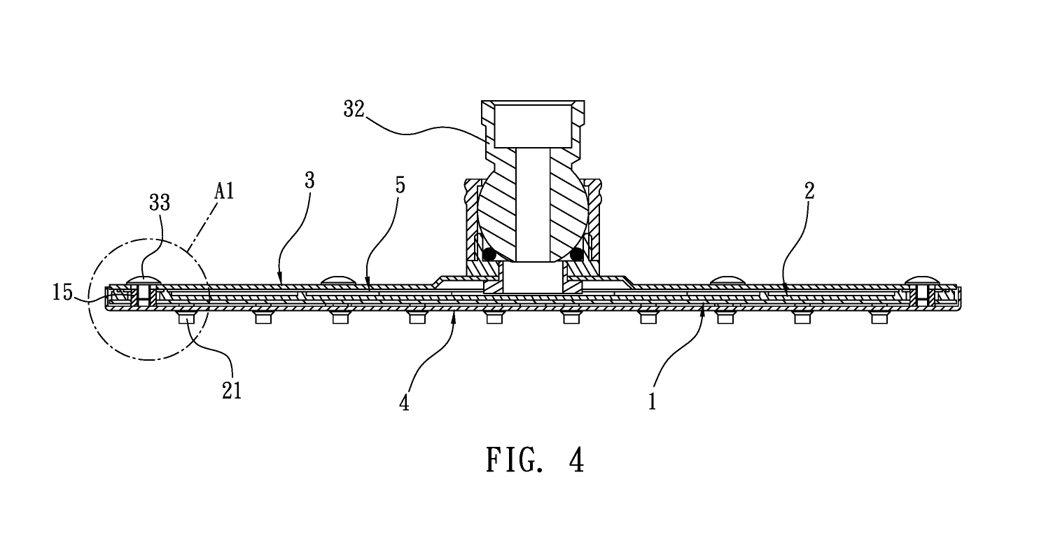

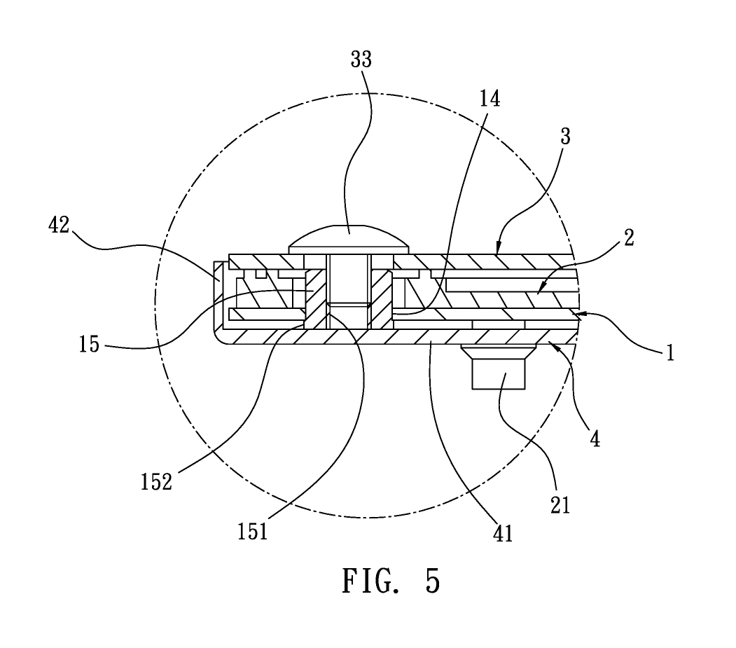

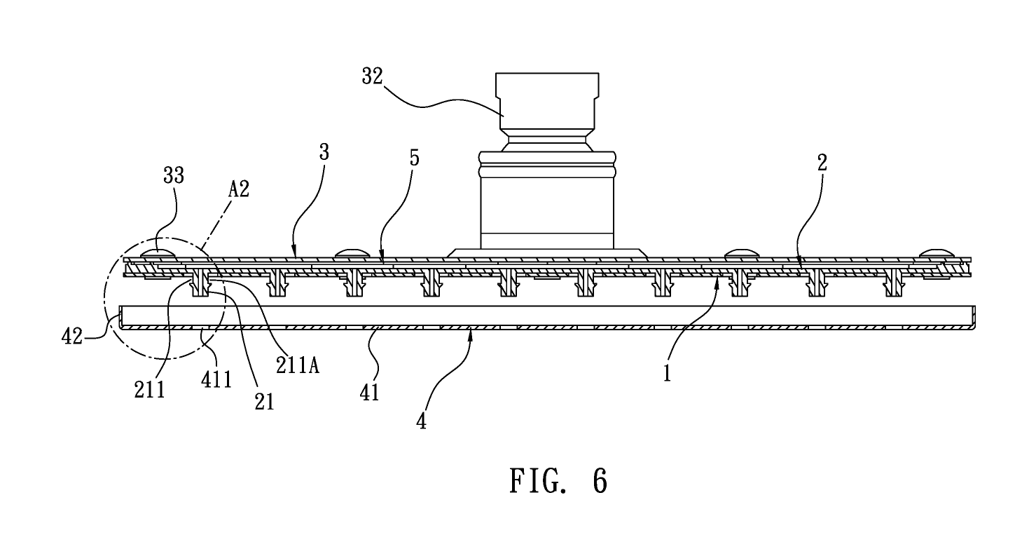

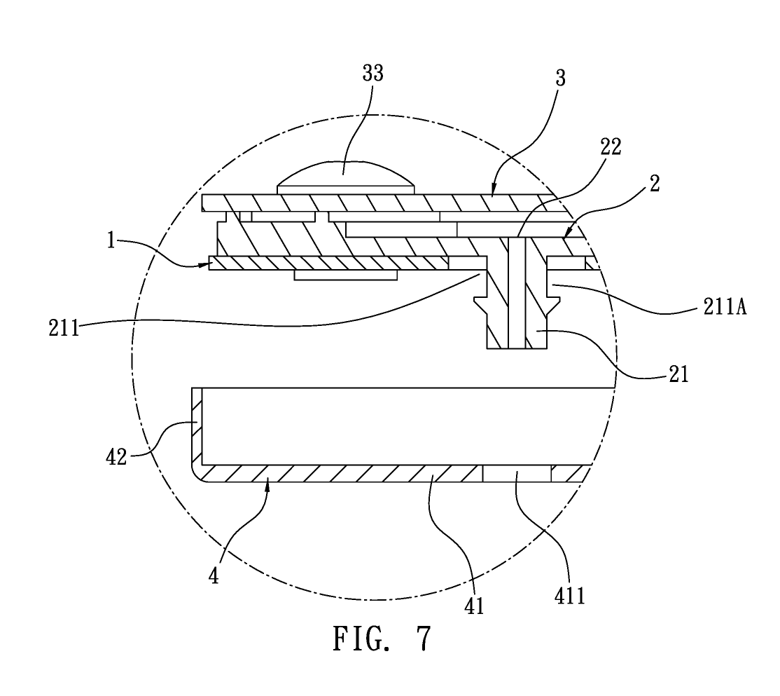

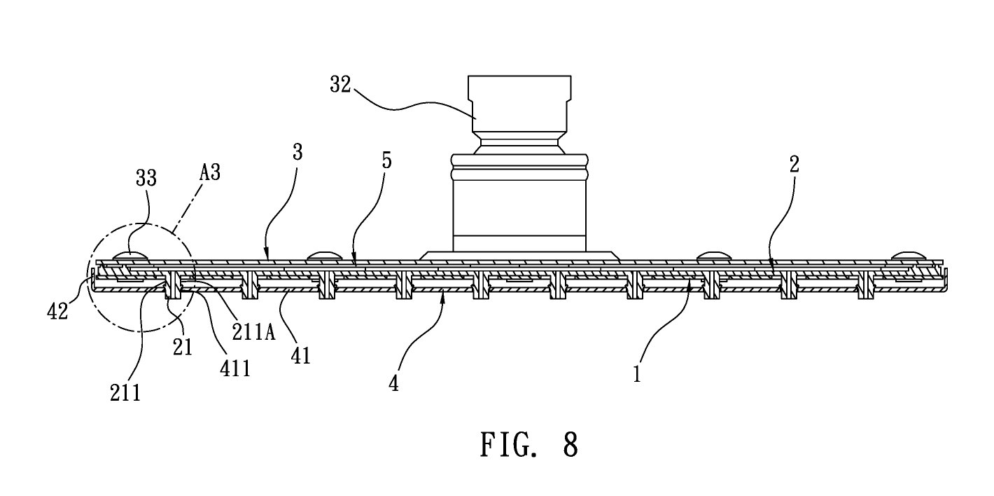

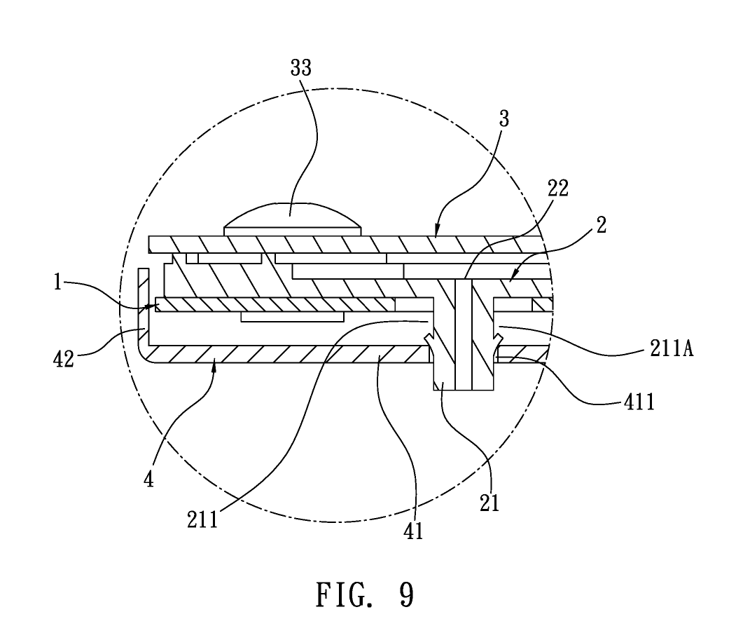

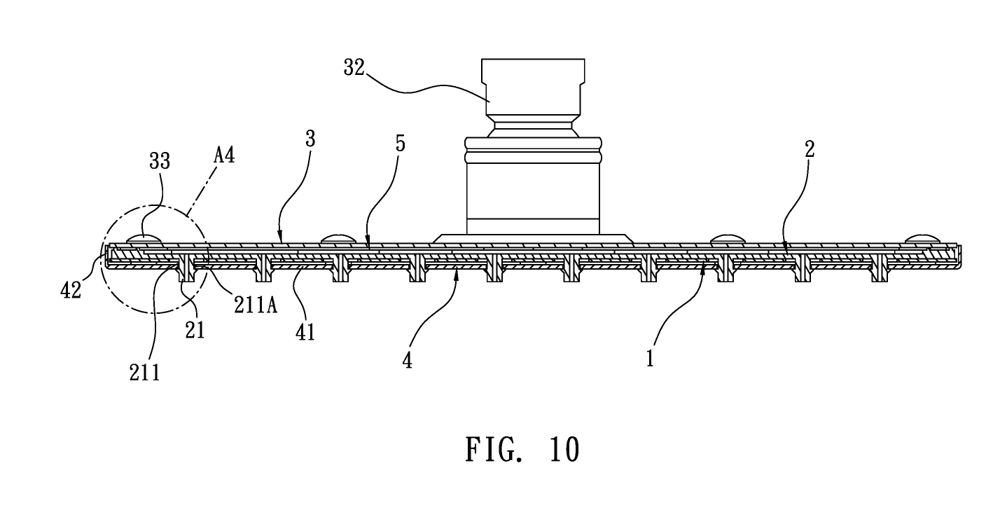

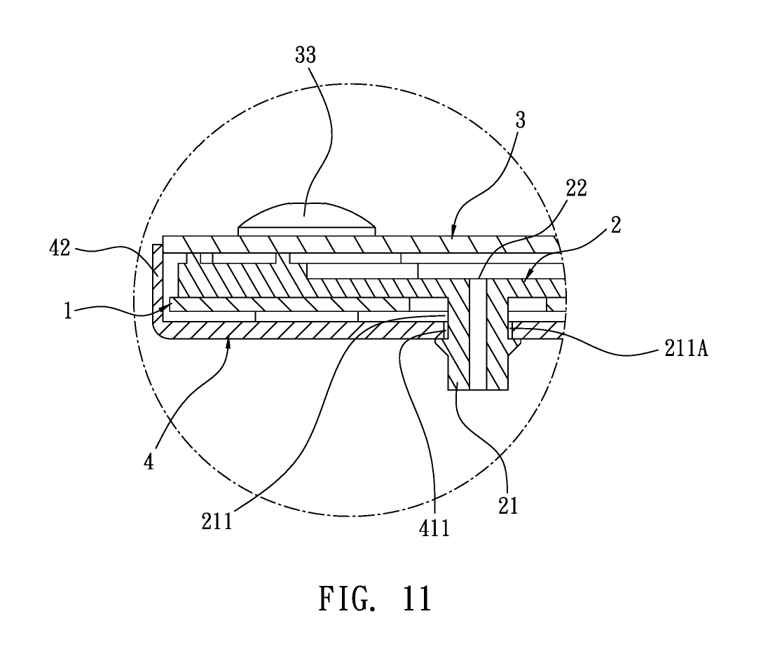

With reference to FIGS. 1-11, a showerhead structure according to a preferred embodiment of the present invention comprises: a water supply disc 1, a water guide disc 2, a covering casing 3, and a decoration cover 4.

The water supply disc 1 is made of metal material so as to withstand a water pressure, and the water supply disc 1 includes a first face 11, a second face 12 opposite to the first face 11, a plurality of through orifices 13 passing through the first face 11 and the second face 12, multiple fixing orifices 14 arranged around a peripheral side of the first face 11 of the water supply disc 1, and a plurality of locking elements 15 fitted in the multiple fixing orifices 14 respectively so as to limit rotations of the plurality of locking elements 15, wherein each locking element 15 has an inner thread 151 formed therein, and each locking element 15 has a stop portion 152 formed on a bottom thereof so that the stop portion 152 of each locking element 15 retains with the first face 11 of the water supply disc 1.

The water guiding disc 2 is flexible and contacts with the second face 12 of the water supply disc 1, and the water guiding disc 2 includes multiple spray protrusions 21 arranged on a first surface thereof facing the water supply disc 1 and extending out of the plurality of through orifices 13 respectively, wherein the water guiding disc 2 includes multiple outlets 210 formed on a second surface thereof away from the water supply disc 1 and communicating with the multiple spray protrusions 21 individually, the spray protrusion 21 has a peripheral trench 211 defined around a peripheral side thereof and extending out of the first face 11 of the water supply disc 1 from the plurality of through orifices 13 of the water supply disc 1 so as to define a retaining space 211A outside the water supply disc 1. The water guiding disc 2 also includes a plurality of apertures 22 arranged proximate to a peripheral side thereof and selectively corresponding to the multiple fixing orifices 14 individually so as to keep away from the plurality of locking elements 15 of the water supply disc 1.

The covering casing 3 is covered on the second face 12 of the water supply disc 1 and includes multiple openings 31 arranged adjacent to a peripheral side of the covering casing 3 and corresponding to the plurality of locking elements 15 of the water supply disc 1 individually. The covering casing 3 further includes a plurality of screws 33 inserting through the multiple openings 31 of the covering casing 3 and the plurality of apertures 22 of the water guiding disc 2 respectively so as to screw with the plurality of locking elements 15 of the water supply disc 1, such that he covering casing 3 is in connection with the water supply disc 1, and the water guiding disc 2 is clamped between the covering casing 3 and the water supply disc 1 so that an accommodation room 5 is defined between the covering casing 3 and the water guiding disc 2 and communicates with the multiple spray protrusions 21. Furthermore, the covering casing 3 further includes a connecting knob 32 disposed on a central position thereof and configured to connect with a water source and to communicate with the accommodation room 5.

The decoration cover 4 is made of metal material and does not withstand the water pressure, and the decoration cover 4 includes a body 41 corresponding to the water supply disc 1 and includes a coupling rib 42 extending upwardly from a peripheral side of the body 41. The body 41 contacts with the first face 11 of the water supply disc 1 and has a plurality of locking holes 411 arranged on the body 41 and corresponding to the plurality of through orifices 13 of the water supply disc 1 individually, wherein each locking hole 411 retains in the retaining space 211A of the peripheral trench 211 of each spray protrusion 21 of the water guiding disc 2 extending out of the first face 11 of the water supply disc 1, such that the decoration cover 4 is engaged by each spray protrusion 21 of the water guiding disc 2 and contacts with the first face 11 of the water supply disc 1, and the coupling rib 42 covers a peripheral side of the water supply disc 1 and the peripheral side of the covering casing 3.

In assembly, the water guiding disc 2 contacts with the second face 12 of the water supply disc 1 so that the multiple spray protrusions 21 of the water guiding disc 2 extend out of the plurality of through orifices 13 of the water supply disc 1 individually, and the peripheral trench 211 of each spray protrusion 21 extends out of the first face 11 of the water supply disc 1 from the plurality of through orifices 13 of the water supply disc 1, wherein a retaining space 211A is defined outside the water supply disc 1, the covering casing 3 is covered on the second face 12 of the water supply disc 1, and the plurality of screws 6 insert through the multiple openings 31 of the covering casing 3 and the plurality of apertures 22 of the water guiding disc 2 respectively so as to screw with the plurality of locking elements 15 which are fitted in the multiple fixing orifices 14 of the water supply disc 1 individually. Thereafter, the body 41 of the decoration cover 4 contacts with the first face 11 of the water supply disc 1, and each locking hole 411 of the body 41 retains in the retaining space 211A of the peripheral trench 211 of each spray protrusion 21 of the water guiding disc 2 extending out of the first face 11 of the water supply disc 1, hence each spray protrusion 21 extends out of the decoration cover 4, and the shower structure is assembled completely.

In operation, the connecting knob 32 connects with a water pipe so that water flows into the accommodation room 5 between the covering casing 3 and the water guiding disc 2, the water supply disc 1 withstands the water pressure, and the water sprays out of each spray protrusion 21 of the water guiding disc 2 via the multiple outlets 210 of the water guiding disc 2 so that user takes a shower.

Thereby, the showerhead structure of the present invention has advantages as follows:

The showerhead structure has outstanding aesthetics appearance by way of the decoration cover 4 and is machined easily in a short time. Preferably, the showerhead structure is manufactured at lower fabrication cost and defective rate, thus increasing market competitiveness.

While we have shown and described various embodiments in accordance with the present invention, it is clear to those skilled in the art that further embodiments may be made without departing from the scope of the present invention.

What is claimed is:

1. A showerhead structure comprising:
a water supply disc made of metal material so as to withstand a water pressure, and the water supply disc including a first face, a second face opposite to the first face, a plurality of through orifices passing through the first face and the second face, multiple fixing orifices arranged around a peripheral side of the water supply disc, and a plurality of locking elements fitted in the multiple fixing orifices respectively so as to limit rotations of the plurality of locking elements, wherein each locking element has an inner thread formed therein, and each locking element has a stop portion formed on a bottom thereof so that the stop portion of each locking element retains with the first face of the water supply disc;
a water guiding disc being flexible and contacting with the second face of the water supply disc, and the water guiding disc including multiple spray protrusions arranged on a first surface of the water guising disc facing the water supply disc and extending out of the plurality of through orifices of the water supply disc respectively, wherein the water guiding disc includes multiple peripheral trenches defined around peripheral sides of the multiple spray protrusions respectively and extending out of the first face of the water supply disc so as to define a retaining space outside the water supply disc, and the water guiding disc also includes a plurality of apertures corresponding to the plurality of locking elements of the water supply disc;
a covering casing covered on the second face of the water supply disc and including multiple openings arranged adjacent to a peripheral side of the covering casing and corresponding to the plurality of locking elements of the water supply disc individually, the covering casing further including a plurality of screws inserting through the multiple openings of the covering casing and the plurality of apertures of the water guiding disc respectively so as to screw with the plurality of locking elements of the water supply disc, such that the water guiding disc is clamped between the covering casing and the water supply disc so that an accommodation room is defined between the covering casing and the water guiding disc, and the covering casing further including a connecting knob configured to connect with a water source and to communicate with the accommodation room;
a decoration cover made of metal material and not withstand the water pressure, and the decoration cover including a body corresponding to the water supply disc and contacting with the first face of the water supply disc, the decoration cover further including a plurality of locking holes arranged on the body and corresponding to the plurality of through orifices of the water supply disc individually, wherein each locking hole retains in the retaining space of the peripheral trench of each spray protrusion of the water guiding disc extending out of the first face of the water supply disc, such that the decoration cover contacts with the first face of the water supply disc.

2. The showerhead structure as claimed in claim 1, wherein the decoration cover also includes a coupling rib extending upwardly from a peripheral side of the body so as to cover a peripheral side of the water supply disc, the peripheral side of the water guiding disc, and a peripheral side of the covering casing.
